(19) United States
(12) Patent Application Publication
(10) Pub. No.: US 2026/0145352 A1
(43) Pub. Date: May 28, 2026

(54) DEVICE AND METHOD FOR RELEASING A WORKPIECE WITH A CUT EDGE

(71) Applicant: TRUMPF Werkzeugmaschinen SE + Co. KG, Ditzingen (DE)

(72) Inventors: Korbinian Weiss, Korntal (DE); Philipp Leube, Stuttgart (DE); Aastha Aastha, Ludwigsburg (DE); Manuel Geiger, Möglingen (DE)

(21) Appl. No.: 19/454,440

(22) Filed: Jan. 21, 2026

Related U.S. Application Data
(63) Continuation of application No. PCT/EP2024/070364, filed on Jul. 18, 2024.

(30) Foreign Application Priority Data
Jul. 25, 2023 (DE) 10 2023 119 564.6

(51) Int. Cl. B26D 7/18

(52) U.S. Cl. CPC B26D 7/18

(57) ABSTRACT

A device for releasing a workpiece with a cut edge, produced by a first machine tool, for a processing process, the device including a detector for detecting a formation of the cut edge and a controller which is configured to release or not release the workpiece for the processing process based on the detected formation of the cut edge. A method for operating the device includes detecting the formation of the cut edge and releasing or not releasing the workpiece for the processing process based on the detected formation of the cut edge.

### CROSS REFERENCE TO RELATED APPLICATIONS

This application is a continuation of International Application No. PCT/EP2024/070364 (WO 2025/021637A1 ), filed on Jul. 18, 2024, and claims benefit to German Patent Application No. DE 10 2023 119 564.6, filed on Jul. 25, 2023. The aforementioned applications are hereby incorporated by reference herein.

### FIELD

The invention relates to a device and to a method for operating a device for releasing a workpiece with a cut edge.

### BACKGROUND

Machine tools are often used to cut a workpiece. After cutting the workpiece, the workpiece has a cut edge created by the machine tool. The formation of the cut edge depends on at least one cutting parameter of the machine tool with which the machine tool created the cut edge. If an unsuitable cutting parameter is used to cut the workpiece, the cut edge may have a machining defect, for example in the form of a burr.

If the cut edge has a machining defect and the workpiece undergoes a processing process such as painting or bending, the machining defect often affects the quality of the processing process. For example, the machining defect may result in not all areas of the workpiece being completely painted or in the workpiece being damaged during bending.

DE 10 2021 200 598 A1 discloses a device for analyzing a cut edge of a workpiece. The workpiece is held in a workpiece holder, wherein the cut edge is illuminated at an acute angle in the cutting direction or against the cutting direction. The roughness and the cut edge bevel can be captured with a camera under such lighting. The camera is used to create a set of cut edge images to characterize the cut edge.

DE 10 2019 209 088 A1 discloses a method for evaluating a laser cut edge of a workpiece. The method comprises the steps of: A) detecting image data of the laser cut edge and its surroundings, B) segmenting the image data and identifying a segment of interest in the image data, wherein the segment of interest comprises image data of the laser cut edge, C) performing image quality detection for the segment of interest, and D) generating an output for a user based on the image quality detection.

### SUMMARY

In an embodiment, the present disclosure provides a device for releasing a workpiece with a cut edge, produced by a first machine tool, for a processing process, the device comprising a detector for detecting a formation of the cut edge and a controller which is configured to release or not release the workpiece for the processing process based on the detected formation of the cut edge.

In an embodiment, a method for operating the device comprises detecting the formation of the cut edge and releasing or not releasing the workpiece for the processing process based on the detected formation of the cut edge.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a schematic view of a device for releasing a workpiece;

FIG. 2 illustrates a schematic view of the workpiece of FIG. 1;

FIG. 3 illustrates a schematic view of a further workpiece;

FIG. 4 illustrates a schematic view of a layout of a flow production with the device of FIG. 1;

FIG. 5 illustrates a schematic flow diagram of a method for operating the device of FIG. 1; and

FIG. 6 illustrates a further schematic flow diagram of the method of FIG. 5.

### DETAILED DESCRIPTION

In an embodiment, the present disclosure provides a device which enables the assurance of a high quality of a processing process and/or the increase of a degree of automation, in particular of a flow production. In an embodiment, the present disclosure also provides a method for operating the device.

A device according to an embodiment of the present disclosure is designed to release a workpiece with a cut edge created by a machine tool for a processing process. The device has a detection means and a control means. The detection means is designed to detect a formation of the cut edge. The control means is designed to release or not release the workpiece for the processing process based on the detected formation of the cut edge.

Advantageously, by releasing the workpiece for the processing process by means of the control means, a degree of automation, in particular of a flow production, can be increased. Advantageously, releasing the workpiece for the processing process ensures that only a released workpiece goes through the processing process, thereby ensuring a high quality of the processing process.

The machine tool can be a cutting machine, in particular a laser cutting machine or a laser cutting system.

The workpiece can be a metal sheet. In particular, a width and/or a length of the workpiece can be more than five times, in particular ten times, a thickness of the workpiece.

The control means can be a computer-implemented control means. The control means can have, in particular be, a computing device, a microcontroller, a computer, a production control system, a manufacturing execution system, a programmable logic controller, and/or an IPC-based controller.

The cut edge can have a machining defect. Detecting the formation of the cut edge can comprise detecting the machining defect. The release or not of the workpiece can be based on the frequency and/or severity of the machining defect. For example, the workpiece cannot be released due to a severe machining defect. For example, the workpiece can be released due to a minor machining defect.

The machining defect can be a burr, a melt tipping over, a slag adhesion, a splash on an upper side and/or on a lower side of the workpiece, a wavy cut start, a groove trail, a roughening, a pitting, a spontaneous combustion, a slagging, a cut surface discoloration, a corner discoloration and/or a cut end discoloration. Additionally or alternatively, the machining defect can be a deviation of a position and/or a position of the cut edge from a predetermined target position and/or a predetermined target position of the cut edge. Additionally or alternatively, the machining defect can be a deviation from a specified target symmetry of the workpiece.

The detected formation of the cut edge can deviate from a specified target formation of the cut edge. The target formation of the cut edge can have a rectangular cross-section. The deviation can occur due to the machining defect. The control means can be designed to evaluate the deviation from the target formation of the cut edge and to compare it with a predetermined limit evaluation. The control means can be designed to release the workpiece if the evaluation of the deviation is equal to or better than the predetermined limit evaluation, and not to release the workpiece if the evaluation of the deviation is worse than the predetermined limit evaluation.

The deviation assessment can be poor if the cut edge has many machining defects and/or severe machining defects. The assessment of the deviation can be good if the cut edge has few machining defects and/or minor machining defects.

The limit assessment can be an assessment of a deviation from the target formation of the cut edge at which a high quality of the processing process can be achieved and/or at which the processing process can be carried out.

A robot can feed the workpiece to the device to release the workpiece for the processing process.

Once the workpiece is released, the workpiece can go through the processing process. If the workpiece is not released, the workpiece cannot go through the processing process.

In an embodiment of the device, the processing process comprises deburring the cut edge, welding the workpiece, bending the workpiece, painting the workpiece and/or punching the workpiece. The processing process can be deburring the cut edge, welding the workpiece, bending the workpiece, painting the workpiece, and/or punching the workpiece.

For example, the processing process can be welding the workpiece, wherein releasing the workpiece ensures that the edges to be welded lie cleanly against each other and do not have any burrs that cause a welding defect.

For example, the processing process can be bending the workpiece, wherein releasing the workpiece ensures that the workpiece to be bent does not have a burr that causes a bending defect.

For example, the processing process can be painting the workpiece, wherein the release of the workpiece ensures that the workpiece to be painted does not have any burrs that cause a painting defect.

In an embodiment of the device, the control means is designed to determine a parameter of the processing process based on the detected formation of the cut edge. Advantageously, the determined parameter enables the workpiece to undergo the processing process, in particular, although the workpiece has the machining defect and/or deviation. For example, a value of the processing process parameter can be determined based on a severity of the recorded formation of the cut edge. The processing process parameter can be determined in such a way that the formation of the cut edge is changed by the processing process. For example, the machining defect and/or deviation can be reduced by means of the processing process.

In an embodiment of the device, the parameter of the processing process has a deburring parameter, a welding parameter, a bending parameter, a painting parameter, and/or a punching parameter. The deburring parameter can include a rotation speed of a tool for deburring the workpiece. The welding parameter can include a welding speed for welding the workpiece. The bending parameter can include a bending force for bending the workpiece. The painting parameter can include a painting direction for painting the workpiece. The punching parameter can include a punching force for punching the workpiece.

In an embodiment of the device, the control means is designed to determine a material parameter of the workpiece and/or an orientation of the workpiece, in particular based on the detected formation of the cut edge. The control means can be designed to release or not release the workpiece for the processing process based on the determined material parameter and/or the determined orientation of the workpiece. The material parameter can be a material type of the workpiece and/or a thickness of the workpiece. The orientation of the workpiece can be a location and/or a position of the workpiece. In particular, the orientation of the workpiece can be an orientation of a top side of the workpiece and/or an orientation of a bottom side of the workpiece.

In an embodiment of the device, the control means is designed to determine, based on the detected formation of the cut edge, whether turning the workpiece is necessary for the processing process. For example, determining whether turning the workpiece is necessary can be based on detecting a top side and/or a bottom side of the workpiece.

Turning the workpiece can be referred to as turning the workpiece over. Turning the workpiece can comprise rotating the workpiece. Turning the workpiece can include a 180° rotation of the workpiece. The control means can be designed to initiate the turning of the workpiece.

For example, turning the workpiece can be necessary if the processing process involves deburring the cut edge and a burr on the cut edge to be removed is facing away from a deburrer. After turning the workpiece, the deburrer can remove the burr. For example, turning the workpiece can be necessary if the processing involves painting one side of the workpiece and a burr faces the cut edge of a painting nozzle. After turning the workpiece, the painting nozzle can paint the side of the workpiece without being affected by the burr.

The control means can be designed to initiate, after turning the workpiece, a feeding of the turned workpiece to the detection means for detecting the formation of the cut edge for the purpose of releasing or not releasing the turned workpiece. The control means can be designed not to release a turned workpiece if the control means determines a turning of the turned workpiece is necessary based on the detected formation of the cut edge of the turned workpiece.

In an embodiment of the device, the control means is designed to determine a processing process upstream of the processing process based on the detected formation of the cut edge from a set of predetermined upstream processing processes. The upstream processing process can be necessary for the smooth running of the processing process. The upstream processing process can be a repeat of the last processing process that the workpiece has undergone. After passing through the upstream processing process, the workpiece can be fed back into the device for the purpose of being released or not being released.

In an embodiment of the device, the set of predetermined upstream processing processes includes at least deburring of the cut edge and/or grinding of the cut edge. For example, the processing process can be painting, wherein the device detects a burr to be removed before painting based on the detected formation of the cut edge and determines deburring of the cut edge as an upstream processing process.

In an embodiment of the device, the control means is designed to optimize at least one cutting parameter of the machine tool based on the detected formation of the cut edge. The control means can be designed to optimize the cutting parameter in such a way that a deviation of a cut edge of another workpiece created by the machine tool and with the optimized cutting parameter from the desired formation of the cut edge is minimized. The control means can be designed to optimize the cutting parameter such that the cut edge does not have any machining defects.

The cutting parameter can be a focus diameter, a laser power, a nozzle focus distance, a nozzle-workpiece distance, a feed rate, a gas pressure, a nozzle diameter, or a gas type.

The control means can be designed to optimize several cutting parameters of the machine tool based on the detected formation of the cut edge, in particular simultaneously.

The detection means can be designed to detect a formation of a cut edge which was created with the optimized cutting parameters, wherein the control means can be designed to optimize the optimized cutting parameters of the machine tool based on the detected formation of the cut edge that was created with the optimized cutting parameters.

In an embodiment of the device, the detection means has an optical sensor, a tactile sensor and/or an acoustic sensor for detecting the formation of the cut edge. The optical sensor can have, in particular be, a camera, in particular a digital camera, for taking a photo of the cut edge and/or a light section sensor, in particular for detecting a height profile of the cut edge. The tactile sensor can have, in particular be, a probe for scanning the cut edge. The acoustic sensor can have, in particular be, an ultrasonic sensor.

In an embodiment of the device, the device has a manipulator for gripping, moving, and/or manipulating the workpiece. The control means is designed to control the manipulator, in particular depending on the detected formation of the cut edge. For example, before the workpiece is released, the control means can control the manipulator in such a way that the workpiece is gripped by the manipulator and moved to the detection means for detecting the formation of the cut edge. For example, after the workpiece has been released, the control means can control the manipulator in such a way that the workpiece is clamped into a machine tool by means of the manipulator to carry out the processing process.

In an embodiment of the device, the detection means is arranged on the manipulator. The detection means can be designed to detect the formation of the cut edge when the workpiece is gripped by the manipulator.

A method according to an embodiment of the present disclosure for operating a device described above includes the steps of: a) detecting the formation of the cut edge and b) releasing or not releasing the workpiece for the processing process based on the detected formation of the cut edge.

Further advantages and advantageous configurations of the present disclosure can be gathered from the drawings and the following description thereof. All features disclosed in in the present disclosure can be essential to the present disclosure both on their own and in any desired combination with one another.

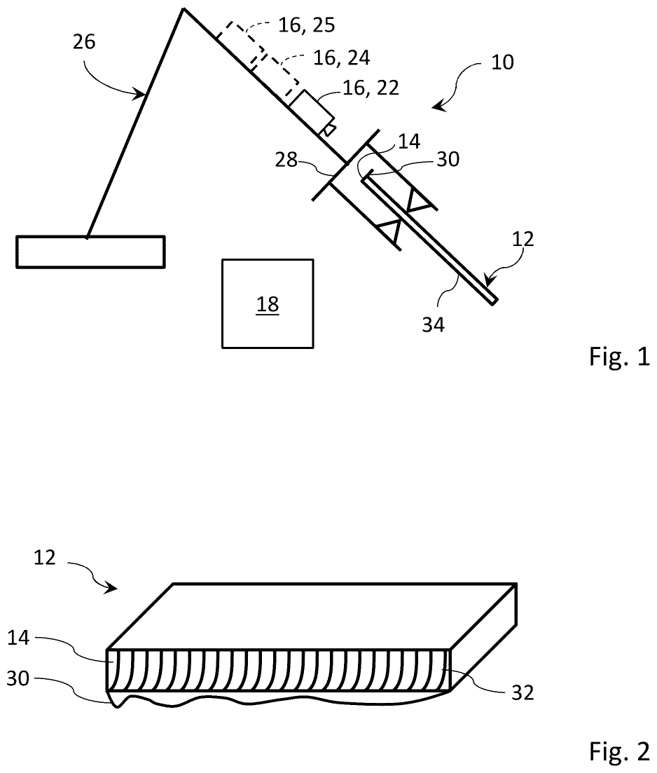

FIG. 1 shows a device 10 for releasing a workpiece 12 with a cut edge 14 created by a machine tool for a processing process.

The device 10 has a manipulator 26 for gripping, moving and manipulating the workpiece 12. The manipulator 26 is a robot with a gripper 28 for gripping the workpiece 12. FIG. 1 shows that the workpiece 12 is gripped by the gripper 28.

The device 10 has a control means 18. The control means 18 is a computer-implemented control means in the form of a computer. The control means 18 is designed to control the manipulator 26. The control means 10 can control the manipulator 26 such that the workpiece 12 is gripped, moved or released by the gripper 28.

The device 10 has a detection means 16 for detecting a formation of the cut edge 14. The detection means 16 has an optical sensor 22 in the form of a digital camera.

In an alternative embodiment, the detection means 16 can, in addition or alternatively to the optical sensor 22, have a tactile sensor 24 and/or an acoustic sensor 25 for detecting the formation of the cut edge 14.

The detection means 16 is arranged on the manipulator 26. The control means 18 has controlled the manipulator 26 such that the cut edge 14 of the workpiece 12 faces the detection means 16. The detection means 16 is designed to detect the formation of the cut edge 14 when the workpiece 12 is gripped by the manipulator 26. The detection means 16 creates a photo of the cut edge 14 of the workpiece 12 gripped by the manipulator 26.

FIG. 2 shows the workpiece 12 gripped by the manipulator 26. The workpiece 12 is a metal sheet. The cut edge 14 was created with the machine tool in the form of a laser cutting machine. The cut edge 14 has a machining defect. The machining defect is a burr 30 and a roughening 32.

The detection of the formation of the cut edge 14 by means of the detection means 16 includes detecting the burr 30 and the roughening 32.

The control means 18 is designed to release or not release the workpiece 12 for the processing process based on the formation of the cut edge 14 detected by the detection means 16. The workpiece 12 being released or not being released is based on a severity of the burr 30 and the roughening 32.

In the example shown in FIG. 2, the burr 30 and the roughening 32 are pronounced in such a way that the processing process is not impaired by the presence of the burr 30 and the roughening 32.

The control means 18 is designed to determine an orientation of the workpiece 12 based on the detected formation of the cut edge 14. In the example shown, the workpiece 12 gripped by the manipulator 26 is oriented such that the cut edge 10 extends orthogonally to a viewing direction of the camera 22. The processing process is not affected by such an orientation of the workpiece 12.

The control means 18 releases the workpiece 12 for the processing process based on the detected formation of the cut edge 14 and the determined orientation of the workpiece 12. Due to the release, the workpiece 12 can go through the processing process.

The control means 18 is designed to determine, based on the detected formation of the cut edge 14, whether turning the workpiece 12 is necessary for the processing process.

In the example shown, the processing process involves painting one side 34 of the workpiece 12 and painting the cut edge 14. FIG. 1 shows that the side 34 points downwards and the burr 30 points upwards as seen from a viewer of FIG. 1. Therefore, based on the orientation of the burr 30, the control means 18 determines that turning the workpiece 12 is necessary for the processing process. Turning the workpiece 12 is rotating the workpiece 12 180°. The control means 10 controls the manipulator 26 in such a way that the workpiece 12 is turned. After turning, the burr 30 points downwards and the side 34 points upwards as seen from a viewer of FIG. 1.

The control means 18 is designed to determine a painting parameter for painting based on the detected formation of the cut edge 14. The painting parameter is a painting direction. The control means 18 determines the painting direction based on the roughening 32 such that when painting the cut edge 14, an applied paint penetrates into the spaces between the roughening 32. This results in a closed paint layer on the cut edge 14. Advantageously, the applied paint fills the spaces between the roughening 32, thereby reducing the severity of the roughening 32.

The control means 18 controls the manipulator 26 in such a way that the workpiece 12 is clamped by means of the manipulator 26 into a machine tool in the form of a painting machine for carrying out the painting.

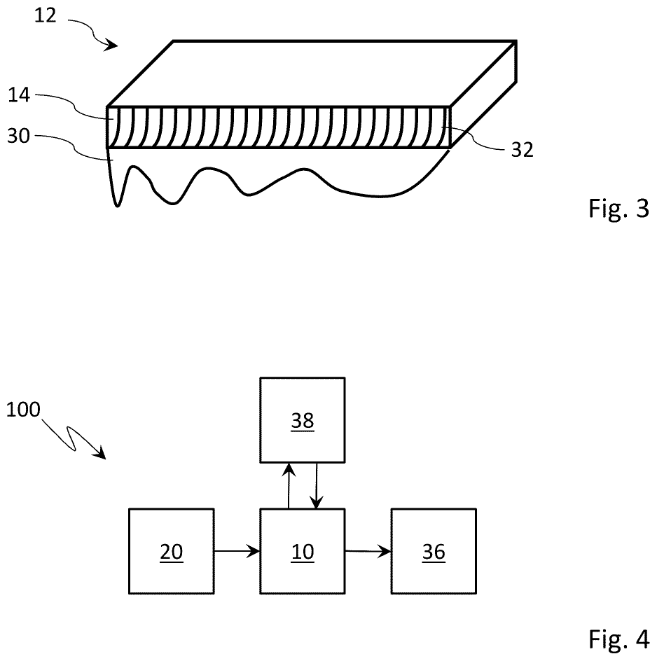

FIG. 3 shows a variant of the workpiece 12 from FIG. 2, wherein the same reference signs are used for identical and functionally equivalent elements and, in this respect, reference can be made to the explanations given above in relation to the exemplary embodiment of FIG. 2, with the result that essentially only the existing differences are discussed.

The workpiece 12 of FIG. 3 has a burr 30 which is so pronounced that the processing process cannot be carried out due to the presence of the burr 30. When the workpiece 12 of FIG. 3 is gripped by the manipulator 26, the formation of the cut edge 14 is detected by the detection means 16. The control means 18 does not release the workpiece 12 for the processing process based on the detected formation of the cut edge 14. Therefore, the workpiece 12 cannot go through the processing process.

The control means 18 is designed to determine a processing process upstream to the processing process from a set of predetermined upstream processing processes based on the detected formation of the cut edge 14. The set of predetermined upstream processing processes includes at least deburring the cut edge 14 and/or grinding the cut edge 14. In the example shown in FIG. 3, the determined upstream processing process is the deburring of the cut edge 14.

The control means 18 is designed to optimize at least one cutting parameter of the machine tool based on the detected formation of the cut edge 14. The control means 18 optimizes the at least one cutting parameter of the machine tool such that further cut edges created with the machine tool using the optimized cutting parameter have no burr 30 or have a burr 30 that is significantly reduced in its severity. The control means 18 is designed to transmit the at least one optimized cutting parameter of the machine tool to the machine tool.

FIG. 4 shows a schematic layout of a flow production 100 with the device 10 of FIG. 1. The device 10 is arranged between the machine tool 20 in the form of the laser cutting machine and the machine tool 36 in the form of the painting machine. In addition, the flow production has a machine tool 38 in the form of a deburring machine.

After creating the cut edge with the laser cutting machine 20, the workpiece 12 is fed to the device 10. The device 10 detects the formation of the cut edge 14 and, based on the detected formation of the cut edge 14, releases the workpiece 12 for painting with the painting machine 36. Due to the release by the device 10, the workpiece 12 is fed to the painting machine 36.

If the device 10 does not release the workpiece 12 for painting with the painting machine 36 and deburring of the cut edge 14 is determined as an upstream processing process, the workpiece 12 is fed to the deburring machine 38. After deburring the cut edge 14 with the deburring machine 38, the workpiece 12 is fed to the device 10. The device 10 detects the formation of the deburred cut edge 14 and, based on the detected formation of the deburred cut edge 14, releases the workpiece 12 for painting with the painting machine 36. Due to the release by the device 10, the workpiece 12 is fed to the painting machine 36.

In an embodiment, the device does not release the workpiece after deburring the cut edge and determines a further deburring of the cut edge as an upstream processing process. The workpiece is fed back to the deburring machine to deburr the cut edge. After the cut edge has been deburred again with the deburring machine, the workpiece is fed to the device for the purpose of releasing or not releasing the workpiece.

In an embodiment, the device does not release the workpiece after deburring the cut edge and determines a further production of the cut edge as an upstream processing process. The workpiece is fed to the machine tool to produce the cut edge again. After the cut edge has been produced again with the machine tool, the workpiece is fed to the device for the purpose of releasing or not releasing the workpiece.

In an embodiment, the device does not release the workpiece after deburring the cut edge and determines a further production of the workpiece as an upstream processing process. The workpiece is fed into the waste and the machine tool is instructed to produce the workpiece again.

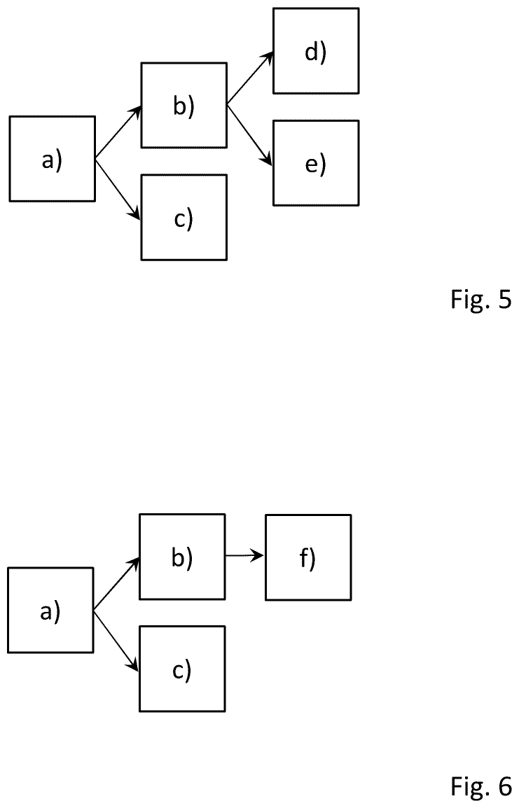

FIG. 5 shows a flow diagram of a method for operating the device 10. The method has the steps of: a) detecting the formation of the cut edge 14 and b) releasing or not releasing the workpiece 12 for the processing process based on the detected formation of the cut edge 14. Simultaneously with step b), the following step is carried out: c) optimizing at least one cutting parameter of the machine tool 20 based on the detected formation of the cut edge 14. In the example shown in FIG. 5, the workpiece 12 has been released in step b). After the release of the workpiece 12, the following steps are carried out: d) determining a parameter of the processing process based on the detected formation of the cut edge 14 and e) determining, based on the detected formation of the cut edge 14, whether turning the workpiece 12 is required for the processing process. Steps d) and e) are carried out simultaneously. In an alternative variant, steps d) and e) can be carried out one after the other.

FIG. 6 shows another schematic flow diagram of the method of FIG. 5. In contrast to the flow diagram in FIG. 5, the workpiece 12 has not been released in step b). After the workpiece 12 has not been released, the following step is carried out: f) determining a processing process upstream to the processing process based on the detected formation of the cut edge 14 from a set of predetermined upstream processing processes.

As the exemplary embodiments shown and explained make clear, the present disclosure provides a device and a method for operating a device which ensure a high quality of a processing process and/or which increase a degree of automation, in particular of a flow production.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A device for releasing a workpiece with a cut edge, produced by a first machine tool, for a processing process, the device comprising:
a detector for detecting a formation of the cut edge; and
a controller which is configured to release or not release the workpiece for the processing process based on the detected formation of the cut edge.

2. The device according to claim 1,
wherein the processing process comprises deburring the cut edge, welding the workpiece, bending the workpiece, painting the workpiece and/or punching the workpiece.

3. The device according to claim 1,
herein the controller is configured to determine a parameter of the processing process based on the detected formation of the cut edge.

4. The device according to claim 3,
wherein the parameter of the processing process comprises a deburring parameter, a welding parameter, a bending parameter, a painting parameter and/or a punching parameter.

5. The device according to claim 1,
wherein the controller is configured to determine a material parameter of the workpiece and/or an orientation of the workpiece.

6. The device according to claim 1,
wherein the controller is configured to determine, based on the detected formation of the cut edge, whether turning the workpiece is necessary for the processing process.

7. The device according to claim 1,
wherein the controller is configured to determine an upstream processing process that occurs upstream to the processing process from a set of predetermined upstream processing processes based on the detected formation of the cut edge.

8. The device according to claim 7,
wherein the set of predetermined upstream processing processes includes at least deburring of the cut edge and/or grinding of the cut edge.

9. The device according to claim 1,
wherein the controller is configured to optimize at least one cutting parameter of the machine tool based on the detected formation of the cut edge.

10. The device according to claim 1,
wherein the detector has an optical sensor, a tactile sensor and/or an acoustic sensor for detecting the formation of the cut edge.

11. The device according to claim 1,
comprising a manipulator for gripping, moving and/or manipulating the workpiece,
wherein the controller is configured to control the manipulator.

12. The device according to claim 11,
wherein the detector is arranged on the manipulator.

13. A method for operating the device according to claim 1, the method comprising:
detecting the formation of the cut edge; and
releasing or not releasing the workpiece for the processing process based on the detected formation of the cut edge.
